(19) United States
(12) Patent Application Publication
(10) Pub. No.: US 2009/0122193 A1
(43) Pub. Date: May 14, 2009

(54) VIDEO PROCESSING APPARATUS AND CONTROL METHOD THEREOF

(75) Inventor: Jae-seung CHO, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/165,757

(22) Filed: Jul. 1, 2008

(30) Foreign Application Priority Data
Nov. 8, 2007 (KR) 2007-113832

(51) Int. Cl. H04N 3/27

(52) U.S. Cl. 348/554; 348/E03.049

(57) ABSTRACT

A video processing apparatus and a control method thereof. The video processing apparatus includes a plurality of connectors to connect to a video signal source, a decoding part which decodes a video signal provided from the video signal source, a switching part which selectively connects any one of the plurality of connectors to the decoding part, and a controller which outputs a control signal to transmit the video signal from the video signal source to the decoding part when the connector connected to the video signal source is connected to the decoding part by the switching part.

### CROSS-REFERENCE TO RELATED APPLICATIONS

This application claims priority under 35 U.S.C. §119(a) from Korean Patent Application No. 10-2007-0113832, filed on Nov. 8, 2007 in the Korean Intellectual Property Office, the disclosure of which is incorporated herein in its entirety by reference.

### BACKGROUND OF THE INVENTION

1. Field of the Invention

The present general inventive concept relates to a video processing apparatus which receives a video signal from a plurality of video signal sources connected thereto, and a control method thereof.

2. Description of the Related Art

In general, a video processing apparatus, such as a television, a monitor, etc., may receive a video signal from a video signal source, such as a DVD player, a computer, a set top box, etc. The video processing apparatus and the video signal source communicate the video signal through an interface, such as HDMI (High Definition Multimedia Interface), DVI (Digital Video Interface), etc.

HDMI and DVI employ a digital video signal transmission protocol which is called TMDS (Transition Minimized Differential Signaling). As illustrated in FIG. 1, in order to realize the HDMI protocol, a video signal converting module which includes a TMDS transmitter 10 and a TMDS receiver 20. The transmitter 10 is installed to the video signal source, and the receiver 20 is installed to the video processing apparatus, so as to transmit a digital video signal to the video processing apparatus from the video signal source.

In such HDMI video signal transmission, the transmitter 10 applies a voltage of 5V to the receiver 20 and determines whether or not the receiver 20 outputs an HPD (Hot Plug Detect) control signal, to thereby determine whether or not the video processing apparatus and the video signal source are connected each other. If the HPD control signal of 5V is outputted, the transmitter 10 determines that the video processing apparatus and the video signal source are normally connected each other and starts DDC (Display Data Channel) communication. Then, the transmitter 10 receives information, such as resolution of the video processing apparatus to which the receiver 20 is installed, and transmits video data to the receiver 20 through the TMDS line.

On the other hand, referring to FIG. 2, a conventional video processing apparatus 30 may be provided with a plurality of connectors 40 for connection with a plurality of video signal sources. A microcomputer 60 is connected with the plurality of connectors 40 and determines whether or not a jack of each video signal source is connected with each connector 40. If the jack is connected with the connector 40, the microcomputer 60 outputs an HPD control signal to transmit a video signal from the video signal source to the receiver 50.

However, in such a conventional video processing apparatus which includes the plurality of connectors, there is a problem that the transmission of the video signal is inefficiently controlled. That is, the microcomputer 60 has a limited number of GPIOs (General Purpose Input/Outputs) for outputting the HPD control signal, for example, three GPIOs corresponding to three connectors of the video processing apparatus. However, if the number of the connectors increases, the GPIOs become insufficient and should increase in size thereof.

### SUMMARY OF THE INVENTION

The present invention provides a video processing apparatus which can efficiently control transmission of a video signal with a limited number of GPIOs, and a control method thereof.

Additional aspects and utilities of the present general inventive concept will be set forth in part in the description which follows and, in part, will be obvious from the description, or may be learned by practice of the present general inventive concept.

The foregoing and/or other aspects and utilities of the present general inventive concept can be achieved by providing a video processing apparatus, including a plurality of connectors to connect to a video signal source, a decoding part which decodes a video signal provided from the video signal source, a switching part which selectively connects any one of the plurality of connectors to the decoding part, and a controller which outputs a control signal to transmit the video signal from the video signal source to the decoding part if the connector connected to the video signal source is connected to the decoding part by the switching part.

When the connector connected to the video signal source is not connected to the decoding part by the switching part, the controller may inform a user that the connector connected to the video signal source is not connected to the decoding part.

The video processing apparatus may further include a user input part through which a user's command is inputted, and the controller may control the switching part to connect any one of the plurality of connectors to the decoding part according to the user's command.

The video processing apparatus may further include a signal inverting part which outputs an inverted control signal inverted from the control signal outputted from the controller.

The control signal may include an HPD control signal.

The video signal source and the connectors may be connected to each other through one of HDMI and DVI.

The each connector may include a TMDS line, a DDC line, and an HPD line.

The foregoing and/or other aspects and utilities of the present general inventive concept can also be achieved by providing a control method of a video processing apparatus having a plurality of connectors to connect to a video signal source, a decoding part which decodes a video signal provided from the video signal source, and a switching part which selectively connects any one of the plurality of connectors to the decoding part, the method including determining whether or not the connector connected to the video signal source is connected to the decoding part by the switching part, and outputting a control signal to transmit the video signal from the video signal source to the decoding part when the connector connected to the video signal source is connected to the decoding part.

The control method may further include informing a user that the connector connected to the video signal source is not connected to the decoding part when the connector connected to the video signal source is not connected to the decoding part.

The control method may further include controlling the switching part to connect any one of the plurality of connectors to the decoding part according to a user's command.

The control method may further include outputting an inverted control signal inverted from the control signal.

The control signal may include an HPD control signal.

The video signal source and the connectors may be connected to each other through one of HDMI and DVI.

The foregoing and/or other aspects and utilities of the present general inventive concept can also be achieved by providing a video processing apparatus, including a plurality of connectors to connect to a plurality of video signal sources, a user input part to allow a user to select one of the plurality of video sources, a decoder to decode a video signal provided by a video signal source through a respective connector, a switching part to selectively connect a connector to the decoding part; and a controller to control transmission of a video signal from the selected video source to the decoder according to a connection status of the corresponding connector.

The controller may output a control signal to transmit the video signal from the selected video source to the decoder when the connector selectively connected to the decoder corresponds to the selected video source.

The controller may inform the user that the video source is not connected to the decoder when the connector selectively connected to the decoder does not correspond to the selected video source.

Each of the plurality of connectors may include one control signal receiving unit, and the controller may include a single control signal transmission unit to transmit the control signal to the plurality of connectors.

The foregoing and/or other aspects and utilities of the present general inventive concept can also be achieved by providing a method of controlling a video processing apparatus, the method including selecting a video source, selectively connecting a connector connected to one of a plurality of video sources to a decoder, determining whether a connector connected to a video source corresponding to the selected video source is connected to the decoder, and outputting a control signal to transmit a video signal from one of the plurality of video sources to the decoder according to a connected status of the connector, wherein the control signal is output when the connector selectively connected to the decoder corresponds to the selected video source.

The video control apparatus may include a controller to generate the control signal, and each of the plurality of connectors may include one control signal receiving unit, and the controller may include a single control signal transmission unit to transmit the control signal to the plurality of connectors.

### BRIEF DESCRIPTION OF THE DRAWINGS

The above and/or other aspects and utilities of the present general inventive concept will become apparent and more readily appreciated from the following description of the exemplary embodiments, taken in conjunction with the accompanying drawings of which:

FIG. 1 is a block diagram schematically illustrating an HDMI interface;

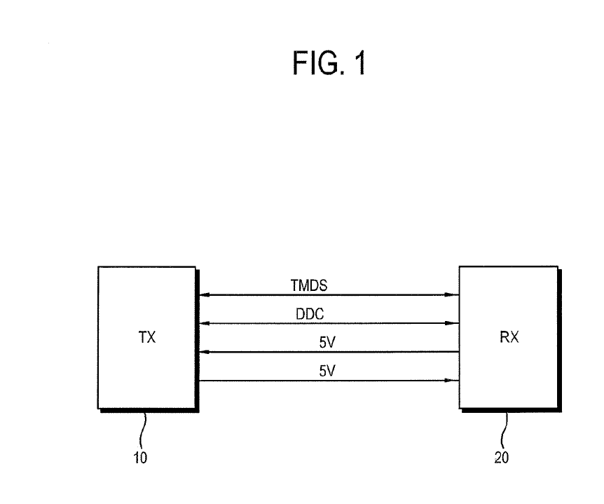

FIG. 2 is a block diagram illustrating a conventional video processing apparatus;

FIG. 3 is a block diagram illustrating a video processing apparatus according to an exemplary embodiment of the present general inventive concept;

FIG. 4 is a block diagram specifically illustrating the video processing apparatus in FIG. 3;

FIG. 5 is a block diagram illustrating a video processing apparatus according to another exemplary embodiment of the present general inventive concept; and

FIG. 6 is a flowchart illustrating a control method of a video processing apparatus according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The exemplary embodiments are described below so as to explain the present general inventive concept by referring to the figures.

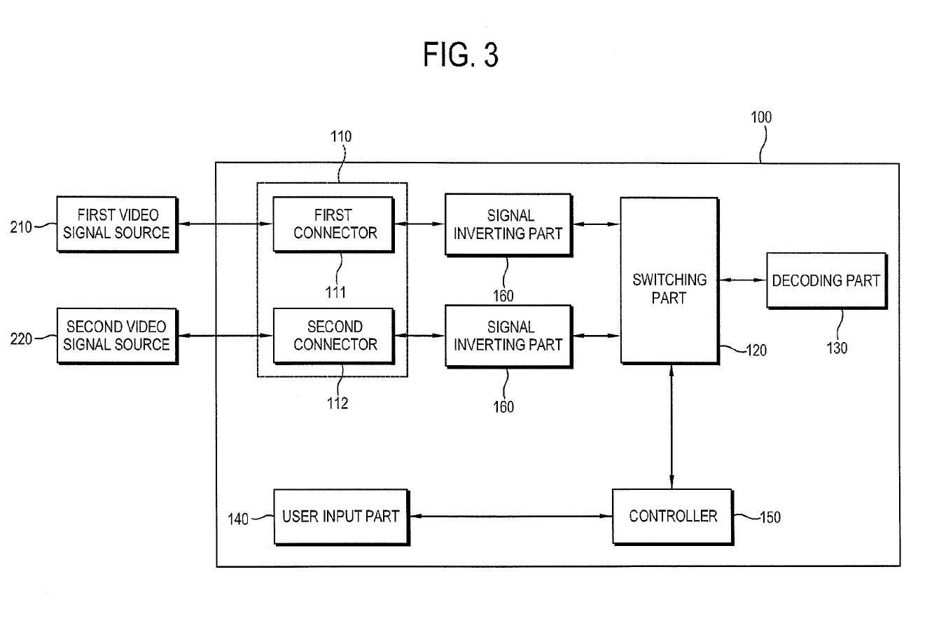

Referring to FIG. 3, a video processing apparatus 100 according to an exemplary embodiment of the present general inventive concept includes a plurality of connectors to connect to a video signal source, and to receive a video signal from the video signal source through the connectors. Here, the video processing apparatus may be provided as a television, a monitor, etc., and may receive the video signal from a video signal source, such as a DVD player, a computer, a set top box, etc., through an interface, such as HDMI or DVI.

As illustrated in FIG. 3, the video processing apparatus 100 may include a plurality of connectors 110, a switching part 120, a decoding part 130, a user input part 140, a controller 150, and a signal inverting part 160.

The video signal source may be connected to the plurality of connectors 110. The plurality of connectors 110 may include a first connector 111 and a second connector 112.

The video signal source may include a first video signal source 210 and a second video signal source 220. The first video signal source 210 may be connected to the first connector 111; and the second video signal source 220 may be connected to the second connector 112.

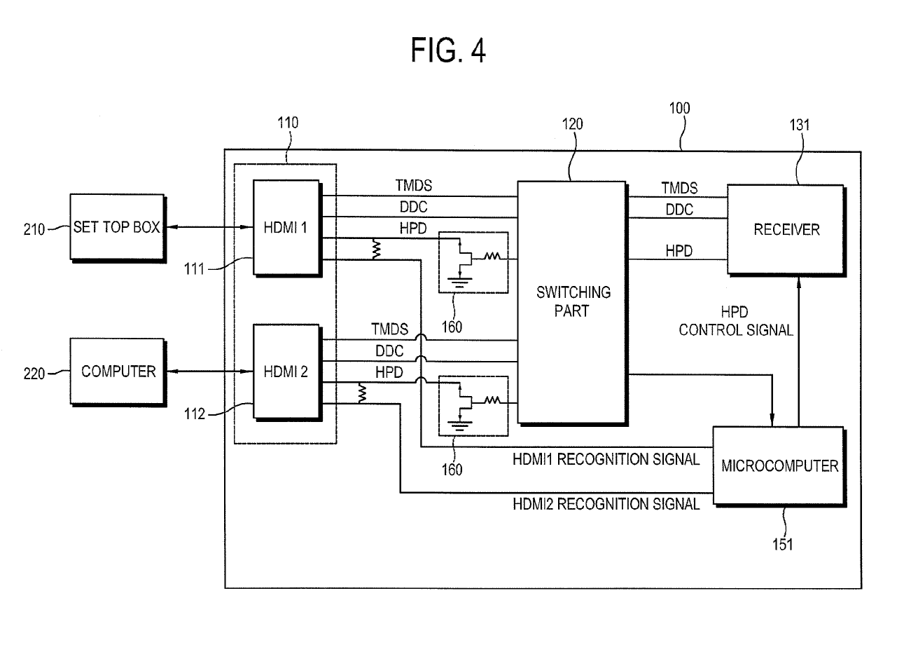

The video signal sources 210 and 220 may be connected to the connectors 111 and 112 through an interface such as HDMI, DVI, etc. The respective connectors 111 and 112 may include a TMDS line, a DDC line and an HPD line. As illustrated in FIG. 4, the connectors 110 may be realized into the HDMI connector 110 or a DVI connector (not illustrated), and the video signal sources 210 and 220 may be realized into a set top box, a computer, etc.

The HDMI connector 110 includes the TMDS line, the DDC line and the HPD line. The TMDS line and the DDC line are connected to a receiver 131 through a switching part 120. The HPD line includes a recognition signal transmission line and an HPD control signal transmission line. The recognition signal transmission line is connected to a microcomputer 151 from the HDMI connector 110 and transmits a recognition signal on whether or not the video signal sources 210 and 220 are connected to the HDMI connector 110. The HPD control signal transmission line is connected to the microcomputer 151 from the HDMI connector 110 through the switching part 120 and transmits an HPD control signal outputted from the microcomputer 151 to the HDMI connector 110.

The switching part 120 selectively connects any one of the plurality of connectors 110 to the decoding part 130. The switching part 120 determines which connector 110 is connected to the decoding part 130 and provides the information to the controller 150. Further, the switching part 120 may select any one of the plurality of connectors 110 under the control of the controller 150 and connect the selected connector to the decoding part 130.

As illustrated in FIG. 4, the TMDS line, the DDC line and the HPD line are connected to the receiver 131 from any one of the plurality of connectors 110 by the switching part 120. The reason why only one of the plurality of connectors 110 is used to connect is because the video processing apparatus 100 processes one video signal to display an image. For example, if a plurality of video signals are inputted into the respective connectors, a user wants to selectively view one of them, and thus, the switching part 120 selects one of the plurality of connectors 110 under the control of the microcomputer 151 according to the user's selection and connects the selected connector to the receiver 131.

The decoding part 130 decodes a video signal transmitted from the video signal source 210 or 220. The decoding part 130 may include the switching part 120, or alternatively, may be included in a video signal processing part (not illustrated). As illustrated in FIG. 4, the decoding part 130 may be realized into the receiver 131 of the HDMI type. The receiver 131 decodes the video signal coded in the HDMI method. The receiver 131 may provide information on the video processing apparatus 100 to the video signal source 210 or 220 through the DDC line. Also, the receiver 131 may transmit the HPD control signal outputted from the microcomputer 151 through the HPD line.

The user input part 140 receives a command from a user. For example, the user input part 140 may include an HDMI channel selection key provided in a remote controller or a television and transmits a command from a user to the controller 150.

If one of the plurality of connectors 110 connected to the video signal source 210 or 220 is connected to the decoding part 130 by the switching part 120, the controller 150 outputs a control signal to transmit a video signal from the video signal source 210 or 220 to the decoding part 130. Here, the control signal may include an HPD control signal. The controller 150 may control the switching part 120 to connect any one of the plurality of connectors 110 according to the user's command.

Further, if the connector 110 which is connected to the video signal source 210 or 220 is not connected to the decoding part 130 by the switching part 120, the controller 150 may inform a user of the fact. For example, if the second connector 112 is connected to the decoding part 130 by the switching part 120 in the state that only the first connector 111 is connected to the video signal source, the controller 150 may inform a user that the video signal source is not connected to the second connector 112 through a display (not illustrated).

For example, if a user selects the second connector 112 to view an image provided from the second video signal source 220 in the state that the first video signal source 210 is connected to the first connector 111 and the second video signal source 220 is connected to the second connector 112, the switching part 120 connects the second connector 112 to the decoding part 130, and then, the controller 150 determines whether or not the switching part 120 has connected the second connector 112 to the decoding part 130 and outputs an HPD control signal. Then, the second video signal source 220 starts to transmit a video signal in response to the HPD control signal.

As illustrated in FIG. 4, the controller 150 may be provided as the microcomputer 151, and the microcomputer 151 may include a plurality of GPIOs. The GPIOs are provided to be used for a processor, a controller, etc. for various purposes. Two of the plurality of GPIOs function as recognition signal transmission lines each corresponding to two HDMI connectors, and one of them functions as the HPD line.

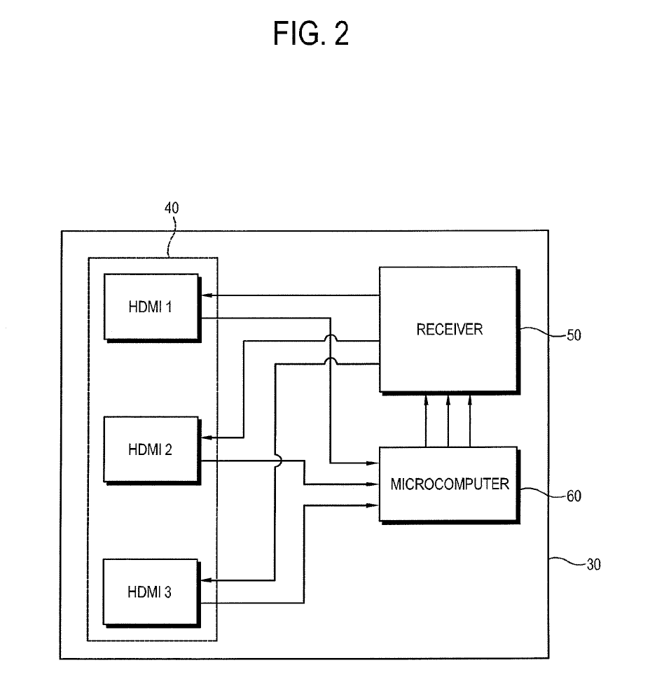

As illustrated in FIG. 2, the microcomputer 60 of the conventional video processing apparatus 30 includes the same number of GPIOs to output the HPD control signal as the number of the connectors. To the contrary, the microcomputer 151 of the video processing apparatus 100 according to the present embodiment includes one GPIO for outputting the HPD control signal irrespective of the number of the connectors, thereby more efficiently using the microcomputer 151. Here, the number of the GPIOs for transmission of the HDMI recognition signal may be the same as the number of the connectors.

As illustrated in FIG. 4, if the video signal sources 210 and 220 are connected to the connectors 110, each connector 110 outputs a voltage of 5V, that is, a high signal to the microcomputer 151 through the recognition transmission line. If not, a voltage of 0V, that is, a low signal is maintained. The high signal is outputted from each of the video signal sources 210 and 220 and transmitted to the microcomputer 151 through the connector 110. That is, the recognition signal includes the high signal and the low signal. The microcomputer 151 receives the recognition signal and determines whether or not the video signal sources 210 and 220 are connected to the connectors 110.

Then, the microcomputer 151 receives information on which connector is switched from the switching part 120 and determines whether or not at least one connector 110 connected to the video signal sources 210 and 220 is connected to the receiver 131 by the switching part 120. That is, the microcomputer 151 transmits the HPD control signal to only the connector connected to the receiver 131 by the switching part 120 among the connectors connected to the video signal sources 210 and 220. This is because if the connectors connected to the video signal sources 210 and 220 are not connected to the receiver 131, the video signal cannot be transmitted to the receiver 131 even if the video signal source concerned starts to transmit the video signal by transmitting the HPD control signal.

As described above, the video processing apparatus 100 according to the present embodiment can more efficiently transmit the HPD control signal to only the connector selected by a user, compared with the conventional video processing apparatus 30 in which the HPD control signal is transmitted to all the connectors to which the video signal sources are connected.

The signal inverting part 160 outputs an inverted control signal inverted from the control signal outputted from the controller 150. The signal inverting part 160 inverts a high HPD control signal outputted from the controller 150 into a low signal, and inverts a low HPD control signal into a high signal. Here, the controller 150 outputs a low signal as an HPD control signal to allow transmission of the video signal, and outputs a high signal as an HPD control signal to prohibit transmission of the video signal. For example, if the first video signal source 210 is connected to the first connector 110 and the first connector 110 is connected to the decoding part 130 by the switching part 120, the controller 150 outputs a low signal; and if not, the controller 150 outputs a high signal. In this case, a voltage of 0V or a low voltage is applied, thereby decreasing possibility of errors and increasing stability of control.

As illustrated in FIG. 4, the signal inverting part 160 may be provided as a transistor between each connector 110 and the switching part 120. Alternatively, the signal inverting part 160 may be provided at an output side of the microcomputer 151.

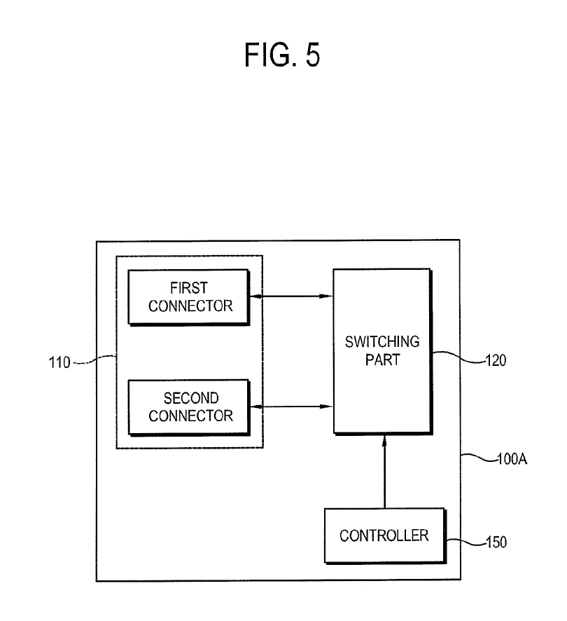

As illustrated in FIG. 5, a video processing apparatus 100A according to another exemplary embodiment of the present general inventive concept may include the plurality of connectors 110, the switching part 120, and the controller 150. These elements are similar as those of the video processing apparatus 100 in FIG. 3, and thus, detailed description thereof will be omitted.

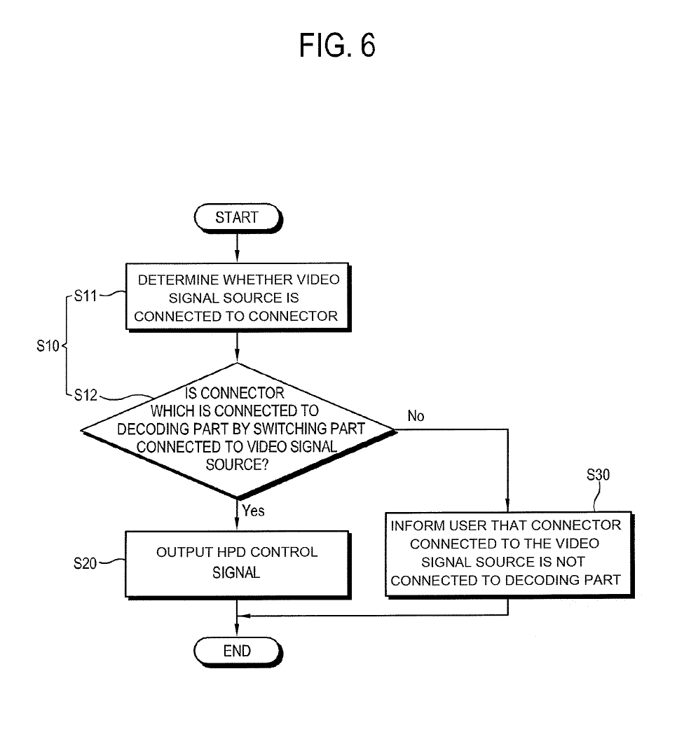

Hereinafter, a control method of a video processing apparatus according to an exemplary embodiment of the present general inventive concept will be described with reference to FIGS. 3 through 6.

First, the video processing apparatus 100 determines whether or not the connector connected to the video signal source 210 or 220 is connected to the decoding part 130 by the switching part 120 in operation S10.

If the connector connected to the video signal source 210 or 220 is connected to the decoding part 130, the video processing apparatus 100 outputs a control signal to transmit a video signal from the video signal source 210 or 220 to the decoding part 130 in operation S20.

In more detail, operation 10 may include operation S11 and operation S12.

First, the video processing apparatus 100 determines whether or not the video signal sources 210 and 220 are connected to the connectors 110 in operation S11. As illustrated in FIG. 4, if the video signal sources 210 and 220 are connected to the connectors 110, each connector 110 outputs a high signal of 5V to the microcomputer 151 through the recognition transmission line. To the contrary, if not, a low signal of 0V is maintained.

Then, the video processing apparatus 100 determines whether or not the connector connected to the decoding part 130 by the switching part 120 is connected to the video signal source in operation S12. For example, if a user selects the second connector 112 to view an image provided from the second video signal source 220 in the state that the first video signal source 210 is connected to the first connector 111 and the second video signal source 220 is connected to the second connector 112, the switching part 120 connects the second connector 112 to the decoding part 130, and then, the controller 150 determines whether or not the switching part 120 has connected the second connector 112 to the decoding part 130.

On the other hand, the video processing apparatus 100 may first determine the connector connected to the decoding part 130 by the switching part 120 among the plurality of connectors, and then, may determine whether or not the connector concerned is connected to the video signal source.

If the connector connected to the video signal source 210 or 220 is connected to the decoding part 130 by the switching part 120 at operation S12, the video processing apparatus 100 outputs an HPD control signal in operation S20. As illustrated in FIG. 4, the controller 150 may be realized as the microcomputer 151, and the microcomputer 151 may include the plurality of GPIOs. Two of the GPIOs are the recognition signal transmission lines each corresponding to two HDMI connectors, and one of them is the HPD line.

If the connector connected to the video signal source 210 or 220 is not connected to the decoding part 130 by the switching part 120 at operation S12, the video processing apparatus 100 informs a user of the fact in operation S30. For example, if the second connector 112 is connected to the decoding part 130 by the switching part 120 in the state that only the first connector 111 is connected to the video signal source, the controller 150 may inform that the second connector 112 is not connected to the video signal source of the user through a display (not illustrated).

As described above, according to the present general inventive concept, it is possible efficiently control transmission of a video signal with a limited number of GPIOs, thereby simplifying a circuit thereof and decreasing manufacturing cost.

Although a few exemplary embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A video processing apparatus, comprising:
a plurality of connectors to connect to a video signal source;
a decoding part which decodes a video signal provided from the video signal source;
a switching part which selectively connects any one of the plurality of connectors to the decoding part; and
a controller which outputs a control signal to transmit the video signal from the video signal source to the decoding part when the connector connected to the video signal source is connected to the decoding part by the switching part.

2. The video processing apparatus according to claim 1, wherein when the connector connected to the video signal source is not connected to the decoding part by the switching part, the controller informs a user that the connector connected to the video signal source is not connected to the decoding part.

3. The video processing apparatus according to claim 1, further comprising:
a user input part through which a user's command is inputted, wherein the controller controls the switching part to connect any one of the plurality of connectors to the decoding part according to the user's command.

4. The video processing apparatus according to claim 2, further comprising:
a user input part through which a user's command is inputted, wherein the controller controls the switching part to connect any one of the plurality of connectors to the decoding part according to the user's command.

5. The video processing apparatus according to claim 1, further comprising:
a signal inverting part which outputs an inverted control signal inverted from the control signal outputted from the controller.

6. The video processing apparatus according to claim 1, wherein the control signal comprises an HPD control signal.

7. The video processing apparatus according to claim 1, wherein the video signal source and the connectors are connected to each other through one of HDMI and DVI.

8. The video processing apparatus according to claim 1, wherein each connector comprises a TMDS line, a DDC line, and an HPD line.

9. A control method of a video processing apparatus having a plurality of connectors to connect to a video signal source, a decoding part which decodes a video signal provided from the video signal source, and a switching part which selectively connects any one of the plurality of connectors to the decoding part, the method comprising:
determining whether or not the connector connected to the video signal source is connected to the decoding part by the switching part; and
outputting a control signal to transmit the video signal from the video signal source to the decoding part when the connector connected to the video signal source is connected to the decoding part.

10. The control method according to claim 9, further comprising:
informing a user that the connector connected to the video signal source is not connected to the decoding part when the connector connected to the video signal source is not connected to the decoding part.

11. The control method according to claim 9, further comprising:
controlling the switching part to connect any one of the plurality of connectors to the decoding part according to a user's command.

12. The control method according to claim 10, further comprising:
controlling the switching part to connect any one of the plurality of connectors to the decoding part according to a user's command.

13. The control method according to claim 9, further comprising:
outputting an inverted control signal inverted from the control signal.

14. The control method according to claim 9, wherein the control signal comprises an HPD control signal.

15. The control method according to claim 9, wherein the video signal source and the connectors are connected to each other through one of HDMI and DVI.

16. A video processing apparatus, comprising:
a plurality of connectors to connect to a plurality of video signal sources;
a user input part to allow a user to select one of the plurality of video sources;
a decoder to decode a video signal provided by a video signal source through a respective connector;
a switching part to selectively connect a connector to the decoding part; and
a controller to control transmission of a video signal from the selected video source to the decoder according to a connection status of the corresponding connector.

17. The video processing apparatus of claim 16, wherein the controller outputs a control signal to transmit the video signal from the selected video source to the decoder when the connector selectively connected to the decoder corresponds to the selected video source.

18. The video processing apparatus of claim 16, wherein the controller informs the user that the video source is not connected to the decoder when the connector selectively connected to the decoder does not correspond to the selected video source.

19. The video processing apparatus of claim 16, wherein each of the plurality of connectors comprises one control signal receiving unit, and the controller comprises a single control signal transmission unit to transmit the control signal to the plurality of connectors.

20. A method of controlling a video processing apparatus, the method comprising:
selecting a video source;
selectively connecting a connector connected to one of a plurality of video sources to a decoder;
determining whether a connector connected to a video source corresponding to the selected video source is connected to the decoder; and
outputting a control signal to transmit a video signal from one of the plurality of video sources to the decoder according to a connected status of the connector,
wherein the control signal is output when the connector selectively connected to the decoder corresponds to the selected video source.

21. The method of claim 20, wherein the video control apparatus comprises a controller to generate the control signal, and each of the plurality of connectors comprises one control signal receiving unit, and the controller comprises a single control signal transmission unit to transmit the control signal to the plurality of connectors.
